(19) United States
(12) Patent Application Publication
(10) Pub. No.: US 2005/0190330 A1
(43) Pub. Date: Sep. 1, 2005

(54) Optical alignment treatment method, manufacturing method of liquid crystal display device, and optical alignment treatment device

(76) Inventor: Kanae Yamanaka, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/066,278

(22) Filed: Feb. 28, 2005

(30) Foreign Application Priority Data
Mar. 1, 2004 (JP) 2004-056736

(51) Int. Cl. G02F 1/1337

(52) U.S. Cl. 349/123

(57) ABSTRACT

A liquid crystal display device is provided with alignment films to which the alignment treatment is applied using a highly reliable optical alignment treatment device. The device includes a plurality of optical fibers which guide light that has been irradiated from a light source, a plurality of collimator lenses which are arranged corresponding to respective irradiation openings of the plurality of optical fibers, and a polarizer which polarizes light irradiated from the plurality of collimator lenses, wherein an alignment film on a substrate is aligned by making use of the light.

### BACKGROUND OF THE INVENTION

The present invention relates to an optical alignment treatment device and a to method which is used to perform the alignment treatment of alignment films of a liquid crystal display device by the irradiation of light to the alignment films. The present invention is suitable for the manufacturing of a liquid crystal display device which receives alignment treatment using optical alignment.

As a method for applying alignment treatment, that is, for imparting an alignment control function to alignment films of the type used in a liquid crystal display device, there is a conventionally known method in which the treatment is performed by rubbing the alignment films. This conventional type of alignment treatment is performed by rubbing the alignment films using a cloth. However, the adhesion of dust from the cloth on the alignment films constitutes one of the causes of the generation of a defective display, and, hence, there has been a demand for an alignment treatment that can be performed other than by rubbing.

In place of the alignment treatment using rubbing, recently, a method has been proposed in which alignment treatment is performed by irradiating light on the alignment films. In U.S. Pat. No. 6,532,047 (literature), which discloses an optical alignment treatment device that is capable of performing alignment treatment by irradiating light to the alignment films, a technique is described which is capable of changing the polarization direction of polarized light that has been irradiated to a substrate, without increasing the area of the substrate.

Further, Japanese Patent Laid-Open Hei08/248231(literature) discloses a liquid crystal display device which produces a display by guarding light from a light source of a projection type liquid crystal display device using optical fibers. For this purpose, light beams, which are obtained by converting the light from the light source into parallel beams using individual lenses, are made to impinge on a liquid crystal display element.

### SUMMARY OF THE INVENTION

As advantages to be achieved in orienting the alignment films using light irradiation, a reduction of the cost, a stabilization of the quality and the like can be named. Although, as a method which performs alignment treatment using light irradiation, the constitution described in the above-mentioned literature 1 maybe considered, the light source used in the method disclosed in literature 1 is a so-called spot light source. Although a spot light source is used due to the need to form parallel light beams when a lens system is used, the lifetime of such a light source is short and the illuminance during use is unstable. Particularly, with respect to a short arc type discharge lamp, which is popularly used for this purpose, there arises a drawback in that the degree of parallelism of the parallel light beams becomes deteriorated due the length of the arc.

Further, there has been a demand for saving space in the design of an optical alignment treatment device per se, however, no consideration is paid to this in the above-mentioned literature 1.

Accordingly, it is an object of the present invention to provide a highly reliable optical alignment treatment device and to a method of manufacture of a liquid crystal display device which is provided with alignment films to which alignment treatment is applied using the device.

The present invention provides an optical alignment treatment device and a method of operation thereof using a light source having a prolonged lifetime or a liquid crystal display device which is subjected to alignment treatment using the method. Further, according to the invention, by realizing the use of a line light source, which is suitable for line scanning or collective treatment as the light source of the optical alignment treatment device, it is possible to prolong the lifetime of the light source of the optical alignment treatment device. Further, it is possible to obtain a manufacturing device and a method of manufacture of a liquid crystal display device which ensures a substantially fixed illuminance during use and which is capable of forming favorable alignment films, or a liquid crystal display device manufactured by these methods. Further, according to the present invention, it is possible to provide an optical alignment treatment device which has improved versatility in the utilization of light.

The present invention is directed to an optical alignment treatment device which includes a light source, a plurality of optical fibers which guide light irradiated from the light source, a plurality of collimator lenses which are arranged corresponding to respective irradiation openings of the plurality of optical fibers, and a polarizer which polarizes light irradiated from the plurality of collimator lenses, wherein an alignment film on a substrate is aligned by making use of the light.

Further, in accordance with the invention, the above-mentioned plurality of optical fibers are arranged such that the optical fibers are divided in at least two regions on the irradiation side.

The present invention can provide an optical alignment treatment device using a light source having a prolonged lifetime by using a linear light source as the above-mentioned light source.

Further, the above-mentioned polarizer is formed of a plurality of polarizers, and the plurality of polarizers can be arranged in an overlapped manner.

The liquid crystal display device according to the present invention includes an alignment film on at least one substrate of a pair of substrates of a liquid crystal panel which constitutes the liquid crystal display device, a liquid crystal layer being formed between the pair of substrates, and on the alignment film which is arranged on the substrate, when collimator lenses are arranged in the closest possible packing arrangement, regions which differ in at least one of the anchoring strength, the film quality, the elastic modulus, the relative imide rate, and the absorption spectrum are regularly repeated. Here, these properties appear in regions which are arranged on an arbitrary straight line with respect to the alignment film on the substrate.

Hereinafter, typical constitutional features of the invention will be enumerated. First of all, an optical alignment treatment device which imparts an alignment control function by irradiating a polarized light to an organic film includes:

(1) a light source;

a plurality of optical fibers which guide light of the light source which is incident from incident ends thereof which are arranged closest to the light source to irradiation ends; and
collimator lenses which are arranged at respective irradiation ends of the plurality of optical fibers.

Alternatively, the optical alignment treatment device includes:

(2) a light source;

a plurality of optical fibers which guide light of the light source is incident from incident ends thereof which are arranged close to the light source to irradiation ends;
a plurality of collimator lenses which are arranged at respective irradiation ends of the plurality of optical fibers; and
a polarization system which polarizes the lights which are incident thereon from the plurality of collimator lenses.
   (3) In the above-mentioned constitution (1) or (2), the light source is a linear light source.
   (4) In the above-mentioned constitution (2) or (3), the plurality of optical fibers are arranged at the irradiation ends thereof in a state such that the optical fibers are divided into at least two regions.
   (5) In the above-mentioned constitution (4), the polarization system is constituted of a plurality of polarizers which are arranged in an overlapped manner.
   (6) In the above-mentioned constitution (4), the polarization system is constituted of a polarization beam splitter or a dielectric multi-layered film.
   (7) In the above-mentioned constitution (5), the plurality of polarizers are arranged in a zigzag manner.

Further, the optical alignment treatment device includes:

(8) a light source;

a plurality of first optical fibers which guide light of the light source is incident from incident ends thereof which are arranged closest to the light source to irradiation ends;
a plurality of collimator lenses which are arranged at respective irradiation ends of the first optical fibers,
a polarization system which polarizes the lights incident from the plurality of collimator lenses; and
second optical fibers which include incident ends for focusing lights which are reflected on the plurality of polarizers and an irradiation end which irradiates the focused lights which are reflected on the polarizers to a substrate.
   (9) In the constitution (8), the incident ends of the second optical fiber are arranged in the periphery of the light source and the irradiation ends are arranged on the substrate.
   (10) In the constitution (2) or (8), the optical alignment treatment device includes a means which operates to tilt the plurality of collimator lenses and the plurality of polarizers.
   (11) In the constitution (2) or (8), the incident sides of the plurality of collimator lenses are arranged in a closest packing arrangement.
   (12) In the constitution (2) or (8), the incident sides of the plurality of collimator lenses are arranged with respect to the scanning direction, while the collimator lenses in a front row are arranged in a repeatedly displaced in either left or right direction at a given pitch for every row.
   (13) In the constitution (11), the irradiation sides of the collimator lenses are arranged in closest packing arrangement.
   (14) In the constitution (11), the incident sides of the plurality of collimator lenses are arranged with respect to the scanning direction, while the collimator lenses in a front row are arranged in a repeatedly displaced in either left or right direction at a given pitch for every row.
   (15) In the constitution (2) or (8), the collimator lenses are arranged in the periphery of the linear light source.
   (16) In the constitution (2) or (8), the linear light sources are arranged such that a plurality of linear light sources are arranged in the longitudinal direction of the linear light sources.
   (17) In the constitution (16), connecting portion of the linear light sources is not provided with incident ends of the optical fibers.
   (18) In the constitution (2) or (8), the linear light sources are arranged such that a plurality of linear light sources are arranged in the lateral direction of the linear light sources.
   (19) In the constitution (2) or (8), the optical alignment treatment device further includes a laser irradiation device which irradiates laser beams to the alignment film on the substrate.

Still further, an optical alignment treatment device includes:

(20) a laser irradiation device which irradiates laser beams;

a light source; and
a plurality of optical fibers which guide light irradiated from the light source.
   (21) In the constitution (20), the optical alignment treatment device further includes:
a plurality of collimator lenses which are arranged to face the respective irradiation ends of the plurality of optical fibers, and
a polarization system which polarizes light irradiated from the plurality of collimator lenses.
   (22) In any one of the constitutions (2), (8) and (20), a cut filter, which cuts wavelengths which are unnecessary for the optical alignment treatment, is arranged on incident sides or irradiation sides of the optical fibers.
   (23) In the constitution (22), the cut filter is arranged to be directly coupled with the incident sides or the irradiation sides of the respective optical fibers.
   (24) Further, with respect to the optical alignment treatment method which imparts an alignment control function to an alignment film formed on a substrate by irradiating light,
light irradiated from a linear light source is guided using a plurality of optical fibers, and
the light is collimated by a plurality of collimator lenses which are arranged to face respective irradiation ends of the plurality of optical fibers in an opposed manner,
the collimated light is polarized, and
the polarized light is irradiated to the alignment film of the substrate.
   (25) In the constitution (24), laser beams are irradiated at the time of irradiating the polarized light to the alignment film of the substrate.
   (26) In the constitution (25), the irradiation of the laser beams is performed before or after the polarized light is irradiated to the alignment film of the substrate.

Further, the liquid crystal display device according to the invention has the following constitution when the collimator lenses are arranged in a closest packing arrangement.

(27) In a liquid crystal display device including a liquid crystal panel which has an alignment film on at least one substrate out of a pair of substrates thereof and has a liquid crystal layer between the pair of substrates,

the alignment film which is arranged on the substrate of the liquid crystal panel is formed in a state that regions where at least one of an anchoring strength, a film quality, an elastic modulus, a relative imide ratio and an absorption spectrum differs from each other are regularly repeated.
   (28) In the constitution (27), with respect to the alignment film of the substrate, in regions on one arbitrary straight line, regions where at least one of anchoring strength, film quality, elastic modulus, relative imide ratio and absorption spectrum differs from each other are regularly repeated.
   (29) Further, with respect to a method of manufacture of a liquid crystal display device which imparts an alignment control function to an alignment film formed on a substrate by irradiating light,
light irradiated from a linear light source is guided using a plurality of optical fibers, and
the light is collimated by a plurality of collimator lenses which are arranged to face respective irradiation ends of the plurality of optical fibers in an opposed manner,
the collimated light is polarized, and
the polarized light is irradiated to the alignment film of the substrate.
   (30) In the constitutions (29), laser beams are irradiated at the time of irradiating the polarized light to the alignment film of the substrate.
   (31) In the constitutions (30), the irradiation of the laser beams is performed before or after the polarized light is irradiated to the alignment film of the substrate.

Here, it is needless to say that the present invention is not limited to the above-mentioned constitutions and the constitutions disclosed in the embodiments to be described later, and that various modifications can be made without departing from the technical concept of the invention.

According to the invention, it is possible to provide a highly reliable optical alignment treatment device and method, as well as a liquid crystal display device which exhibits a high display quality.

### BRIEF DESCRIPTION OF THE SEVERAL VIEWS OF THE DRAWINGS

FIG. 1 is a diagram showing the constitution of an embodiment 1 of an optical alignment treatment device according to the present invention;

FIG. 2 is a diagram showing the light paths of light after the light is irradiated from irradiation ends of optical fibers;

FIG. 3 is a diagram showing the arrangement of collimator lenses;

FIG. 4 is a diagram showing the constitution of an embodiment 2 of the optical alignment treatment device according to the present invention;

FIG. 5 is a diagram showing the constitution of an embodiment 3 of the optical alignment treatment device according to the present invention;

FIG. 6 is a diagram showing the constitution of an embodiment 4 of the optical alignment treatment device according to the invention;

FIG. 7 is a sectional view of a liquid crystal display device having an alignment film to which an alignment control function is imparted by an alignment method according to the present invention; and

FIG. 8 is a diagram showing another arrangement of the collimator lenses.

### DETAILED DESCRIPTION OF THE INVENTION

Hereinafter, embodiments of a liquid crystal display device according to the present invention will be explained in conjunction with the drawings.

### Embodiment 1

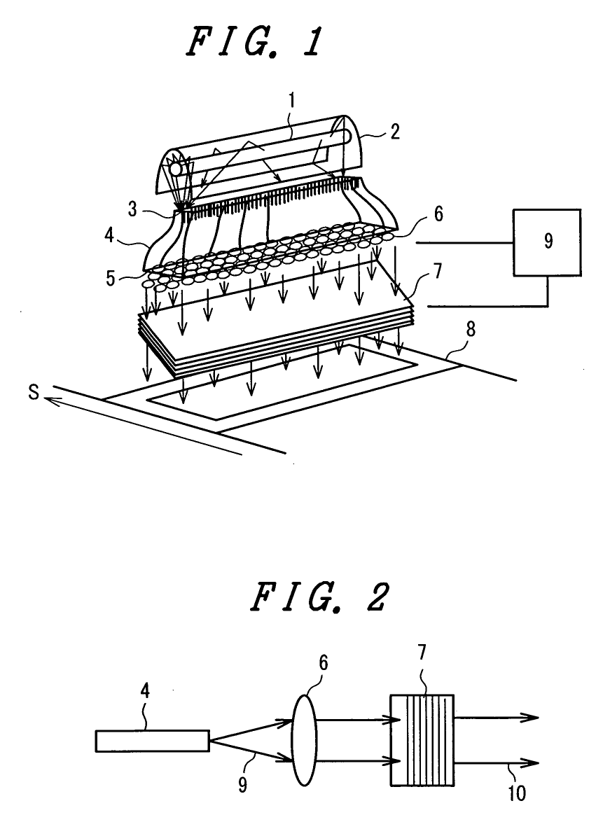

FIG. 1 is a diagram showing the constitution of an embodiment 1 of an optical alignment treatment device according to the present invention.

In FIG. 1, light having no directivity that is irradiated from a linear light source 1 is focused on a focusing portion 3 using a reflector 2. At this focusing portion 3, the light incident ends of a plurality of optical fibers 4 are arranged. The positions of the respective irradiation ends of the optical fibers 4 are represented by a rectangular shape 5. Hereinafter, these positions will be referred to as irradiation ends 5. On respective irradiation ends of the optical fibers 4, collimator lenses 6 are mounted. At a stage following the collimator lenses 6, a polarization system 7 is arranged. In the polarization system 7, the light which is polarized through the polarization system 7 is irradiated to an alignment film formed on a substrate 8. An arrow S indicates the scanning direction.

As shown in FIG. 2, the light which pass through the inside of the optical fibers 4 is irradiated from the irradiation ends 5 of the optical fibers 4 with a given spreading of directivity 9 of the optical fibers. In conformity with this spreading of the directivity, the collimator lenses 6 are arranged corresponding to the irradiation ends 5 of the plurality of optical fibers 4. The collimator lens 6 is a lens which converts the incident light into parallel beams, and the light, which is converted into the parallel beams using the collimator lens 6, passes through the polarization system 7, which is arranged next to the collimator lens 6, and the light is divided into a P wave 10, which is necessary for the optical alignment, and S waves, which are unnecessary (not shown in the drawing). Here, the polarization system 7 is constituted by arranging a plurality of polarizers in an overlapped manner at a Brewster's angle. The P wave 10 is irradiated to the substrate 8 (to which an alignment film is applied), which is arranged below the polarization system 7, thus enabling the optical alignment treatment.

With respect to the polarization system 7, besides the constitution (polarization pile) shown in FIG. 1, in which the polarizers are stacked in an overlapped manner, a polarized splitter or a dielectric multilayered film also can be used. Here, when the optical fibers 4 or the collimator lenses 6 are arranged horizontally, as shown in FIG. 1, there exists a possibility that the optical fibers 4 or the collimator lenses 6 will be deformed by the gravitational load due to the dead weight thereof. As a countermeasure for such deformation, it is possible to provide a method in which the exposure is performed in a state such that the optical fibers 4 and the collimator lenses 6 are fixed using a suitable structure, are split, or the whole assembly of the optical fibers 4 and the collimator lenses 6 is arranged vertically or the substrate is held upright.

Further, to cut unnecessary wavelengths for the optical alignment treatment, it is also possible to arrange a cut filter for cutting unnecessary wavelengths on the incident end or the irradiation end of each optical fiber.

This cut filter also may be directly arranged on or coupled to the incident end or the irradiation end of each optical fiber.

Although the use of an electrode-equipped lamp as the linear light source 1 also maybe considered, it is believed that the use of a non-electrode-equipped lamp as the linear light source 1 is effective in the case of the embodiment 1. This is because the non-electrode-equipped lamp has a prolonged lifetime, is low in cost and exhibits a stable illuminance.

Further, the optical fibers 4 may preferably be made of a material which efficiently transmits the wavelengths necessary for the optical alignment. Further, when ideal parallel light beams are demanded, it is possible to consider the irradiation end per se of each optical fiber as a spot light source, and, hence, the use of optical fibers having a smaller diameter is preferable. Here, it is needless to say that, although spot light sources have a shorter lifetime compared with a linear light source, by using spot light sources in place of the linear light source and by focusing the light beams from the spot light sources using optical fibers, the optical alignment treatment can be performed in the same manner as the above-mentioned embodiment.

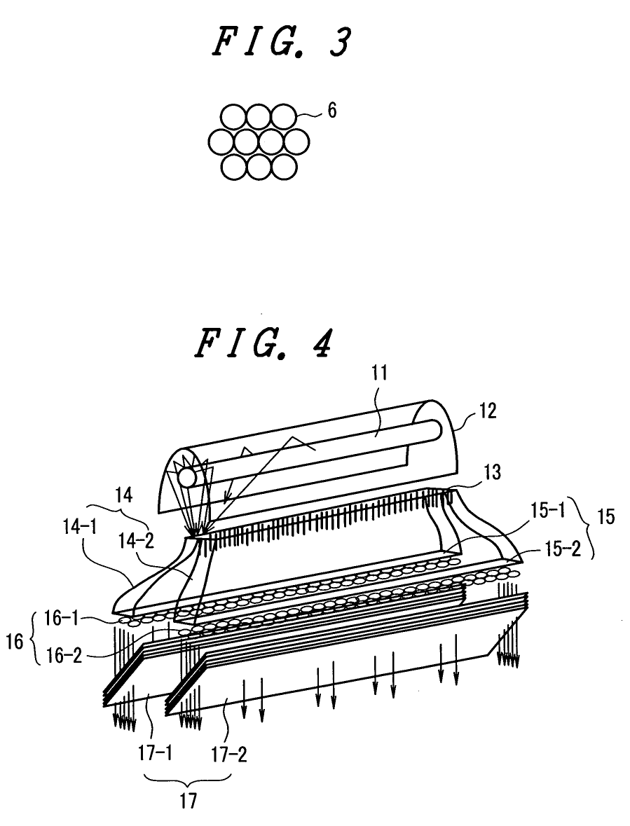

FIG. 3 is a diagram showing the arrangement of the collimator lenses.

With respect to the arrangement of the collimator lenses 6 in FIG. 3, to overcome the irregularities of illuminance attributed to the joint portions of the collimator lenses 6, the collimator lenses 6 are arranged in an offset manner in adjacent rows (closest possible packing arrangement). In this constitution, at the time of radiating the light to the alignment film, it is possible to further eliminate irregularities in the illuminance using a method in which the radiation of the light is performed by scanning with the light beams.

Although, in the embodiment 1 which has been explained in conjunction with FIG. 1 to FIG. 3, the optical alignment treatment device adopts a constitution in which the light irradiated from the linear light source 1 is focused on the focusing portion using the reflector 2, which surrounds the linear light source 1 while having an opening portion therein, the optical alignment treatment device can also adopt a constitution in which the light is focused by directly arranging the incident ends of the optical fibers 4 on the portion where the reflector 2 is arranged (periphery of the linear light source 1). Further, although not shown in the drawing, to focus the light irradiated from the linear light source 1, it is also possible to perform optical alignment treatment by arranging the incident sides of additional optical fibers in the periphery of the light source and by arranging the irradiation sides of the additional optical fibers on the substrate, and by allowing the light to impinge on the substrate.

Further, in the embodiment 1 which has been explained in conjunction with FIG. 1 to FIG. 3, the explanation is based on a constitution in which one linear light source 1 is provided. However, it is also possible to adopt a constitution in which a plurality of linear light sources are arranged in the longitudinal direction of the linear light sources or in the lateral direction of the linear light sources. When a plurality of linear light sources are arranged in the longitudinal direction of the linear light sources and the incident ends of the optical fibers are arranged in the periphery of the linear light sources, it is not always necessary to arrange the incident ends of optical fibers on the joint portions between the linear light sources.

Further, although not shown in detail in the drawing, in the constitution of FIG. 1, by providing a tilting unit 9, which tilts the collimator lenses 6 and the polarization system 7 on the irradiation ends of the optical fibers in the lateral direction (in the direction parallel to the substrate to which the light is irradiated) at the time of irradiating the light, it is possible to cause a distribution of the light (displacement of the axis, light extinction ratio and irregularities of illuminance) derived from the oscillating optical system to be more uniform.

In this manner, the alignment film on which the optical alignment treatment is performed using the optical alignment treatment device of the embodiment 1 is characterized in that the regions which differ in at least one of the anchoring strength, the film quality, the elastic modulus, the relative imide rate and the absorption spectrum are regularly repeated. Here, this phenomenon appears in regions which are arranged on one arbitrary straight line with respect to the alignment film on the substrate. This is because, in the case where the light is radiated by arranging the circular collimator lenses 6 in the closest possible packing arrangement, as seen in FIG. 3, due to the gap between the collimator lenses 6, regions which receive a large amount of irradiated light and regions which receive a small amount of irradiated light are generated even when the collimator lenses 6 are slightly tilted using the tilting means, and, accordingly, the above-mentioned irregularities of properties are generated on the alignment films.

Further, in the embodiment 1, the optical fibers 4 are arranged such that the light beams radiated from the optical fibers 4 have the same irradiation direction. However, the optical fibers may be divided into several groups so that the irradiation directions of the light beams are different from each other. For example, it is possible to effect exposure from a plurality of directions, such as from above, from an oblique direction or the like.

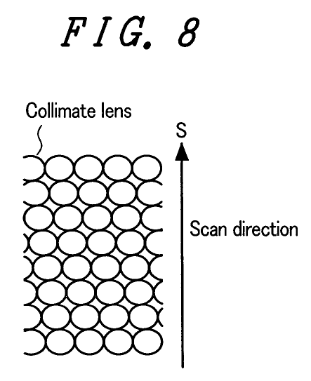

FIG. 8 shows another possible arrangement of the collimator lenses, which is different from the arrangement shown in FIG. 3. Although in FIG. 3, the collimator lenses are offset in adjacent rows (closest possible packing arrangement), in FIG. 8, the collimator lenses are displaced with a given pitch in either one of the left and right directions perpendicular to the scanning direction S. When the collimator lenses are arranged in such a manner, the scanning distance may not cover the whole range in which the collimator lenses are arranged, and the scanning may be performed until another collimator lens reaches the same position as the position of one collimator lens. According to this constitution, which is different from the constitution shown in FIG. 3, it is possible to obtain an alignment film having uniform properties, while having no brightness irregularities.

### Embodiment 2

FIG. 4 is a diagram showing the constitution of an embodiment 2 of the optical alignment treatment device according to the present invention. The constitution shown in the embodiment 2 is different from the constitution shown in FIG. 1 in that the polarization system is divided. In FIG. 4, in the periphery of a linear light source 11, in substantially the same manner as shown in FIG. 1, a reflector 12 is arranged with an opening on one side thereof. On a focusing portion 13 formed by the reflector 12, the light incident ends of optical fibers 14 are arranged. The optical fibers 14 are divided into two systems consisting of optical fibers 14-1 and optical fibers 14-2, and the optical fibers 14 of these two systems provide two irradiation ends consisting of an irradiation ends 15-1 and an irradiation ends 15-2.

On the respective irradiation ends 15-1 and irradiation ends 15-2, collimator lenses 16-1 and 16-2 are arranged, respectively. Here, with respect to a polarization system 17, which is arranged at a stage which follows the collimator lenses 16-1 and 16-2, corresponding to the respective collimator lenses 16-1 and 16-2, a polarization system 17-1 and a polarization system 17-2 are arranged.

The constitution described for this embodiment 2 is favorable when the light radiation is performed on a large-sized substrate. That is, the constitution is provided for solving drawbacks which are generated when it becomes necessary to perform the irradiation of light on a large-sized substrate, and, hence, the optical fibers 14 and the collimator lenses 16 respectively constitute one sheet having a large surface corresponding to the area of the substrate.

That is, it is considered that, when the irradiation side of the optical fibers and the collimator lenses respectively constitute sheets having large surfaces, due to the dead weight of the optical fibers and the collimator lenses, the load in the gravity direction against the supporting force becomes large, and, hence, there arise drawbacks in that the sheet surface is broken or deformed. Accordingly, as a countermeasure to cope with these drawbacks, the irradiation opening of the optical fibers and the polarization system of the collimator lenses are divided.

Also, with respect to this embodiment, a tilting means of the collimator lens and polarization system may be provided in the same manner as the embodiment 1, as shown in FIG. 1.

According to the constitution of this embodiment 2, irrespective of the position of the light source (light emitting part), necessary light beams can be irradiated in all directions. For example, by dividing the optical fibers and arranging the optical fibers in left and right directions from one light source, the light can be irradiated in the horizontal direction, and, hence, a two-row simultaneous processing (scanning), which requires a small space and in which the substrate is arranged in an upright manner, can be realized. Here, the number of divisions of the optical fibers, the collimator lenses and the polarization systems is not limited to the above-mentioned two systems, and the number may be three or more.

### Embodiment 3

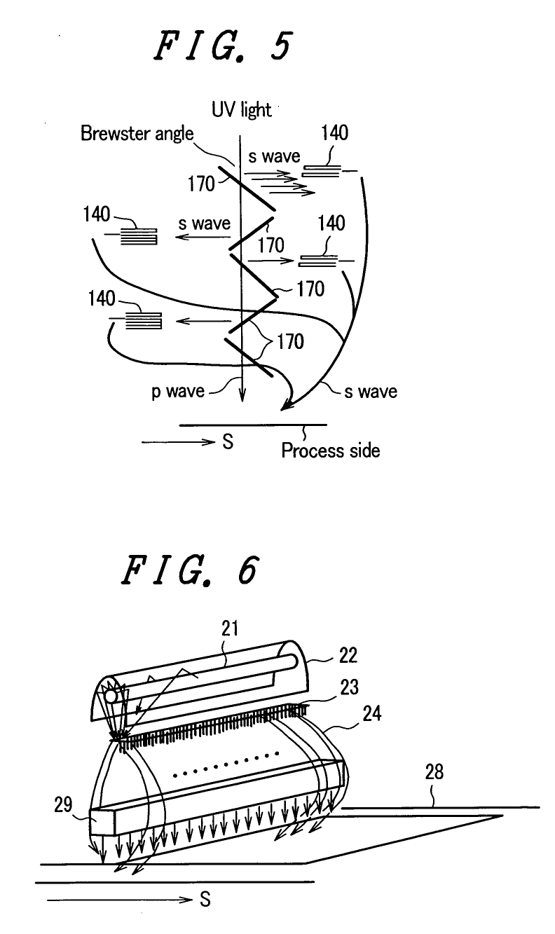

FIG. 5 is a diagram showing the constitution of part of an embodiment 3 of the optical alignment treatment device according to the present invention. In FIG. 5, the optical system or the like in a front stage of a polarizer 170 has the same constitution as the embodiments described in conjunction with FIG. 1 or FIG. 4. Here, in the embodiment 3, the optical fibers (numeral 4 in FIG. 1, numeral 14 in FIG. 4), which guide the light into the polarizer 170, are referred to as first optical fibers. In the passage of light UV, which is irradiated from a collimator lens, a plurality of polarizers 170 are arranged in a zigzag shape at a Brewster's angle. In the peripheries of the polarizers 170, second optical fibers 140 are provided which focus the polarized light having an S wave, which cannot not pass through the polarizers 170. An arrow S indicates the scanning direction.

With the use of this embodiment, from the polarizers 170, only a P wave passes through and is radiated on the alignment film (processing surface) of the substrate. The S wave, which cannot not pass through the polarizers 170, is focused by the second optical fibers 140, which are arranged at the peripheries of the polarizers 170, and is radiated to the alignment film (processing surface) of the substrate. By adopting this constitution, the alignment treatment can be performed using the P wave, and control of a pretilt angle can be performed using the S wave, and, hence, the constitution is effective for the TN type liquid crystal display device. Here, the method in which the light reflected on the polarizers is focused by the second optical fibers 140, is not limited to the case in which the polarizers are arranged in a zigzag shape as shown in FIG. 5. It is needless to say that the method is applicable to a case in which the polarizers are arranged in the same manner as shown in FIG. 1.

### Embodiment 4

FIG. 6 shows an embodiment 4 of the optical alignment treatment device according to the present invention. This embodiment has a constitution in which optical fibers and a laser are used in combination. For example, using an optical alignment treatment device having the same constitution as shown in FIG. 4, light having a specific wavelength, which is desired to be radiated by a larger amount in view of the treatment, is compensated by irradiating laser beams from a laser irradiation device 29. An arrow S indicates the scanning direction.

In this case, there are no specific conditions with respect to the arrangement order or shape of the irradiation ends of the optical fibers 24, or the timing of the treatment using the optical fibers 24 and the laser treatment, the arrangement positions or the like. For example, it is possible for the laser beams to be radiated in such a manner that the radiation of the laser beams overlaps the period during which the polarized light beams are radiated on the alignment film of the substrate 28, or for the radiation of the laser to be performed before or after the polarized light beams are radiated on the alignment film of the substrate 28. The constitution of this embodiment is also applicable to of the embodiment shown in FIG. 4.

Further, it is needless to say that, to compensate the laser beams emitted from the laser irradiating device 29, the light may be guided using the optical fibers 24, the irradiation ends of the optical fibers 24 may be arranged at desired positions; and, corresponding to necessity, the collimator lenses and the polarization system may be arranged as well. Further, it does not matter whether or not the light which is guided using the optical fibers 24 is polarized light.

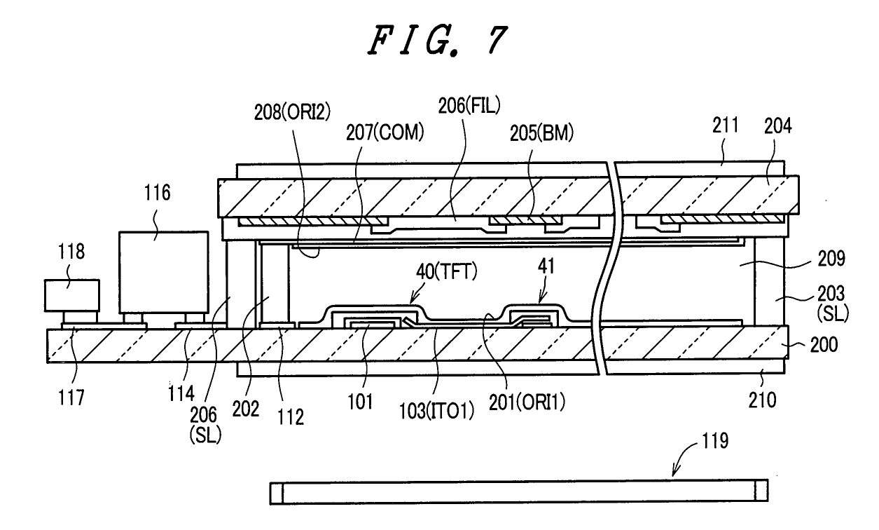

FIG. 7 is a cross-sectional view showing one example of a liquid crystal display device which is provided with alignment films to which alignment control is imparted using the alignment method according to the present invention. A liquid crystal panel, which constitutes this liquid crystal display device, is constituted by laminating an active matrix substrate 200, on which thin film transistors (TFT) 40, load capacitances (Cadd) 41, pixel electrodes (ITO1) 103 and a lower alignment film (ORI1) 201 are formed on an effective display region thereof, and a color filter substrate 204, on which a black matrix (BM) 205, color filters (FIL) 206, a common electrode (COM) 207 and an upper alignment film (ORI2) are formed. Here, liquid crystal (LC) 209 is sandwiched in the lamination gap, and the peripheries of the active matrix substrate 200 and the color filter substrate 204 are fixed to each other by a sealing material (SL) 203, thus integrating the active matrix substrate 200 and the color filter substrate 204.

Here, to at least one of the above-mentioned lower alignment film (ORI1) 201 and the upper alignment film (ORI2) 208, an alignment control function is imparted using the above-mentioned optical alignment treatment.

Between a common electrode wiring terminal 112 of the active matrix substrate 200 and the common electrode 207 of the color filter substrate 204, an electrical connection is established using a conductive paste 202. An image signal electrode wiring terminal 114, which is led from this common electrode wiring terminal 112, is positioned on an outer side of the sealing material SL, and an image signal electrode drive circuit (IC chip) 116 is mounted in such a manner that the image signal electrode drive circuit (IC chip) 116 bridges between the image signal electrode wiring terminal 114 and an outer connection terminal 117. Here, to the outer connection terminal 117, a terminal of an outer drive circuit wiring (printed circuit board or the like) 118 is connected. The liquid crystal (LC) 209 is, on interfaces with two alignment films 201 (ORI1) and 208 (ORI2), initially aligned using a liquid crystal alignment control function which is imparted to the respective alignment films.

Further, although a cross section on a lead side of the image signal electrode wiring terminal 114 is shown in FIG. 7, the structure on a lead side of the scanning electrode wiring terminal is also constituted in the same manner. Here, on the back surface of this liquid crystal panel, a backlight (BL) 119, including a light guide plate and a linear lamp, is mounted, and the backlight (BL) illuminates the liquid crystal panel from a back surface, with the result that a visible image is formed on an effective display region of the liquid crystal panel. Further, although not shown in the drawing, between the above-mentioned liquid crystal panel and the backlight, an optical compensation member, such as a light diffusion sheet, a prism sheet or the like, is arranged and housed in an appropriate casing, thus constituting the liquid crystal display device.

The invention is not limited to the constitution which has been explained heretofore and in which a liquid crystal alignment control function is imparted to the alignment films constituting the liquid crystal panel of the liquid crystal display device, since the invention is also applicable generally to various treatments of an organic film using light energy.

1. An optical alignment treatment method which imparts an alignment control function to an alignment film formed on a substrate by irradiating light;
light irradiated from a linear light source is guided using a plurality of optical fibers, and the light is collimated by a plurality of collimator lenses which are arranged to face respective irradiation ends of the plurality of optical fibers in an opposed manner,
a collimated light is polarized, and
a polarized light is irradiated to the alignment film of the substrate.

2. An optical alignment treatment method according to claim 1, wherein laser beams are irradiated at the time of irradiating the polarized light to the alignment film of the substrate.

3. An optical alignment treatment method according to claim 2, wherein the irradiation of the laser beams is performed before or after the polarized light is irradiated to the alignment film of the substrate.

4. A manufacturing method of a liquid crystal display device which forms an alignment film to which an alignment control function is imparted on a substrate by irradiating light, wherein
a light irradiated from a linear light source is guided using a plurality of optical fibers, and
the light is collimated by a plurality of collimator lenses which are arranged to face respective irradiation ends of the plurality of optical fibers in an opposed manner,
a collimated light is polarized, and
a polarized light is irradiated to the alignment film of the substrate.

5. A manufacturing method of a liquid crystal display device according to claim 4, laser beams are irradiated at the time of irradiating the polarized light to the alignment film of the substrate.

6. A manufacturing method of a liquid crystal display device according to claim 5, wherein the irradiation of the laser beams is performed before or after the polarized light is irradiated to the alignment film of the substrate.

7. An optical alignment treatment device which imparts an alignment control function to an alignment film formed on a substrate by irradiating light to the organic film, the optical alignment device comprising:
a light source;
a plurality of optical fibers which guide light of the light source is incident from incident ends thereof which are arranged close to the light source to irradiation ends; and
a plurality of collimator lenses which are arranged at respective irradiation ends of the plurality of optical fibers; and
a polarization system which polarizes the lights which are incident thereon from the plurality of collimator lenses.

8. An optical alignment treatment device according to claim 7, wherein the light source is a linear light source.

9. An optical alignment treatment device according to claim 8, wherein the plurality of optical fibers are arranged at the irradiation ends thereof in a state that the optical fibers are divided into at least two regions.

10. An optical alignment treatment device according to claim 9, wherein the polarization system is constituted of a plurality of polarizers which are arranged in an overlapped manner.

11. An optical alignment treatment device according to claim 10, wherein the plurality of polarizers are arranged in a zigzag manner.

12. An optical alignment treatment device according to claim 9, wherein the plurality of polarizers are arranged in a zigzag manner.

13. An optical alignment treatment device according to claim 7, wherein the plurality of optical fibers are arranged at the irradiation ends thereof in a state that the optical fibers are divided into at least two regions.

14. An optical alignment treatment device according to claim 7, wherein the optical alignment treatment device includes a means which tilts the plurality of collimator lenses and the plurality of polarizers.

15. An optical alignment treatment device according to claim 7, wherein the incident sides of the plurality of collimator lenses are arranged in a closest packing arrangement.

16. An optical alignment treatment device according to claim 7, wherein the incident sides of the plurality of collimator lenses are arranged with respect to the scanning direction, while the collimator lenses in a front row are arranged in a repeatedly displaced in either left or right direction at a given pitch for every row.

17. An optical alignment treatment device according to claim 7, wherein the collimator lenses are arranged in the periphery of the linear light source.

18. An optical alignment treatment device according to claim 7, wherein the linear light sources are arranged such that a plurality of linear light sources are arranged in the longitudinal direction of the linear light sources.

19. An optical alignment treatment device according to claim 7, wherein the linear light sources are arranged such that a plurality of linear light sources are arranged in the lateral direction of the linear light sources.

20. An optical alignment treatment device according to claim 7, wherein the optical alignment treatment device further includes a laser irradiation device which irradiates laser beams on the orientation film on the substrate.
